(19) United States
(12) Patent Application Publication
(10) Pub. No.: US 2002/0003198 A1
(43) Pub. Date: Jan. 10, 2002

(54) Angle of elevation adjusting device for display

(76) Inventors: Gary Kuan-Hong Hsieh, Taipei (TW); Robert Hsieh, Taipei (TW)

Correspondence Address: RABIN & CHAMPAGNE, P.C., 1101 14 Street, N.W., Suite500, Washington, DC, 20005, US

(21) Appl. No.: 09/864,174

(22) Filed: May 25, 2001

(30) Foreign Application Priority Data
Jul. 5, 2000 (TW) 089211518

(51) Int. Cl. F16M 11/20; A47B 91/00

(52) U.S. Cl. 248/351; 248/188.8

(57) ABSTRACT

At the back bottom half of the LCD display there extends a supporting means that has a shaft lever at its free end, an adjusting unit can pivot on the shaft lever via a shaft hole; the adjusting unit has multiple planes and the distance from the virtual center of shaft hole to the edge of each plane of the adjusting unit has at least two different lengths; revolving the adjusting unit to let its different plane osculate the desk or the platform, the included angle of the supporting means and the platform can be changed forwardly or backwardly.

### FIELD OF INVENTION

The present invention relates to a computer display supporting device, especially that can conveniently adjust an angle of elevation of flat panel display, esp. LCD monitor, to maintain a best angle of elevation of view for different computer users according to their respective stature or sitting posture with the use of a simple angle of elevation adjusting device.

### BACKGROUND OF INVENTION

Display must have different angle of elevation of view for different computer users according to their different stature or sitting posture. Otherwise it would cause discomfort for user to closely watch display for a long time.

This issue of ergonomics has been paid much attention by many researchers of computer display, e.g., relevant prior art is disclosed in U.S. Pat. No. 5,758,849. Onemore prior art is disclosed in U.S. Pat. No. 5,597,218; a wedge-like structure is adapted for incorporation into a monitor support assembly, so that the monitor tilt angle is adjustable relative to the assembly by the wedge-like structure.

U.S. Pat. No. 4,919,387 is provided that a support apparatus for easily and independently adjusting tilt and swivel of a visual display device such as a computer monitor. The tilt mechanism utilizes a stack of elongate torsion springs or bars with the stack's mid-portion fixed against longitudinal rotation and with its ends rotatable, including means for providing resistance to such rotation, for counter-balancing the torque produced by the display device in its various tilt positions. The swivel mechanism permits the display device to be swiveled through a rotational angle greater than 360 degree., or greater than 180.degree. in each direction from a front reference position.

U.S. Pat. No. 4,731,030 is to provide a loose leaf holder specially used for computer display. Furthermore, U.S. Pat. No. 4,708,313 is to provide a a tilt apparatus allows an operator to change the tilt angle of a display monitor and retain the angle after it is changed. The tilt apparatus mounts vertically to the display monitor housing at the rear of the monitor's pivot point and center of gravity; and the apparatus includes a piston and spring assembly which counterbalances shifting in the monitor's center of gravity during the manual tilting of the monitor to provide continuously variable adjustment throughout a predefined tilt range.

### SUMMARY OF THE INVENTION

An object of this invention is to provide a simple structure to construct display angle of elevation adjusting device.

Another object of this invention is to provide a device that can be used to conveniently adjust forward or backward angle of elevation of flat panel display.

This invention designs a supporting portion at the bottom of the flat panel display, such as a computer LCD monitor, that can support the display on desk or on any platform. There extends backward from the back of the display a supporting means that is used to integrate an adjusting unit.

The adjusting unit has multiple planes that are pivoted on the shaft lever supporting the display via shaft hole or other equivalent modes. The section plane of the multi-plane adjusting unit is typically a triangle or quadrangle or other polygon. The virtual center of shaft hole of the adjusting unit is not what is called “geometric center” of the adjusting unit. In other words, the distance from the virtual center of shaft hole to each plane of the adjusting unit has at least two different lengths. The display is actually supported by the adjusting unit pivoted on the shaft lever and the supporting portion at the bottom of the display. Therefore, if the adjusting unit is revolved to let its different plane osculate the desk or the platform, the included angle of the supporting means and the platform can be changed, adjusting forward or backward angle of elevation of the display accordingly.

A preferred embodiment is that at each side of the bottom of display there is a supporting portion and at each side, there extends backward a supporting means that has a bent shaft lever at its free end. The preferred embodiment is to bend inward each free end of the supporting means to form a shaft lever to integrate an adjusting unit. Another preferred embodiment is to connect the two shaft levers to form a unity.

A further preferred embodiment is that three supporting points support the display, wherein the two supporting portions at both sides of the bottom of the display, and the adjusting unit pivoted on the shaft lever. Employ a strip-supporting portion at the bottom of the display and an adjusting unit pivoted on the shaft lever to support the display jointly is another preferred embodiment.

A method of supporting the display can also be implemented as a supporting means that bias extends backward from the back of the display and that has a bent shaft lever at its free end to integrate the adjusting unit. Further preferred embodiment is that each side of the free end of the supporting means has a shaft lever to integrate the adjusting unit.

Whatever method is employed, it is apparent that if the adjusting unit is revolved to let its different plane osculate the desk or the platform, the included angle of the supporting means and the platform can be changed. With the implementation of this technology of changing the included angle of the supporting means and the platform, it would be very convenient for users to adjust forward or backward angle of elevation of the display accordingly.

### BRIEF DESCRIPTION OF FIGURES

The attached figures illustrate the preferred embodiments of this invention.

FIG. 1 is the lateral view of preferred embodiment of this angle of elevation adjusting device for flat panel display.

FIG. 2 is the vertical view of FIG. 1.

FIG. 3 is selective enlargement of FIG. 1 and section along line 3-3 in FIG. 2.

FIG. 4 is similar to FIG. 3 but illustrates another adjusting mode.

FIG. 5 is similar to FIG. 3 but illustrates a second preferred embodiment.

FIGS. 6, 7 and 8 are similar to FIG. 2 but illustrate preferred embodiment of different supporting means.

FIG. 9 illustrates the relationship graph of how the included angle changes with the change of distance from the center of shaft hole to the edge of each plane accordingly.

### DETAILED DESCRIPTION OF THE PREFERRED EMBODIMENT

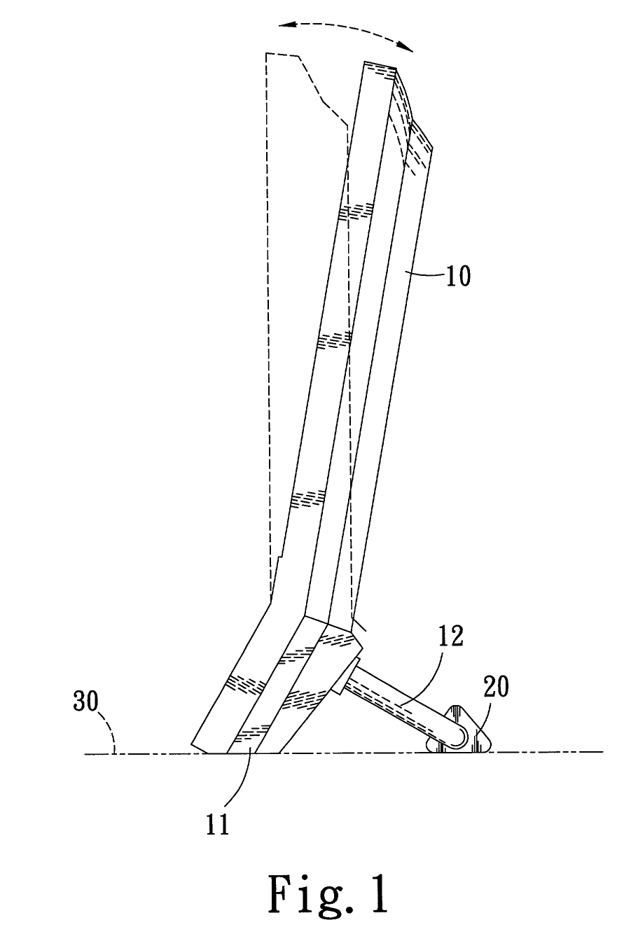

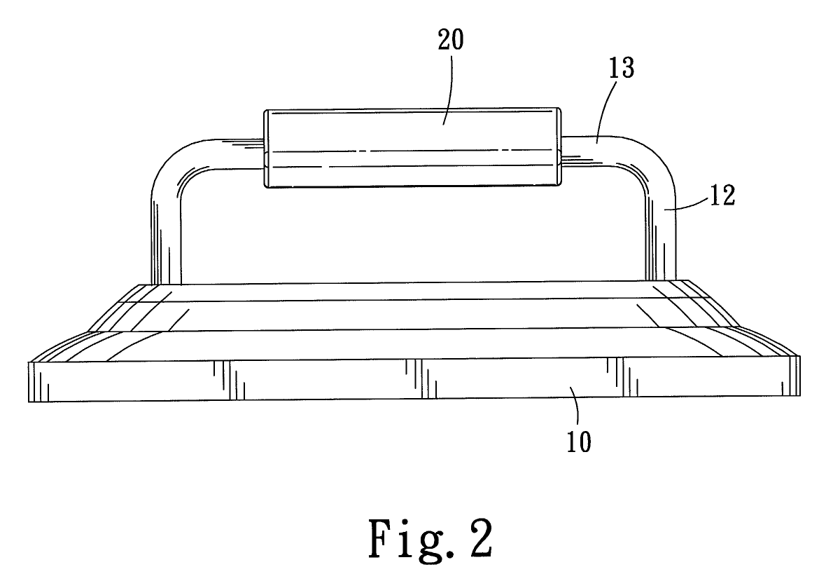

Please refer to FIGS. 1 and 2, a device of this invention mainly comprises a supporting means (12) adapted at the back bottom half of a flat panel display (10); and an adjusting unit (20) integrated with the supporting means (12) and therefore can adjust forward or backward angle of elevation of the display (10) along the imaginary line shown in FIG. 1.

The flat panel display (10) is supported on a platform (30) by a supporting portion (11) at its bottom as shown in FIG. 1. From the back bottom half of the display (10) extends a supporting means (12) whose free end has a bent shaft lever (13) to be integrated with the adjusting unit (20). A preferred embodiment is to connect the two shaft levers with each other (as shown in FIG. 2) to form a unity.

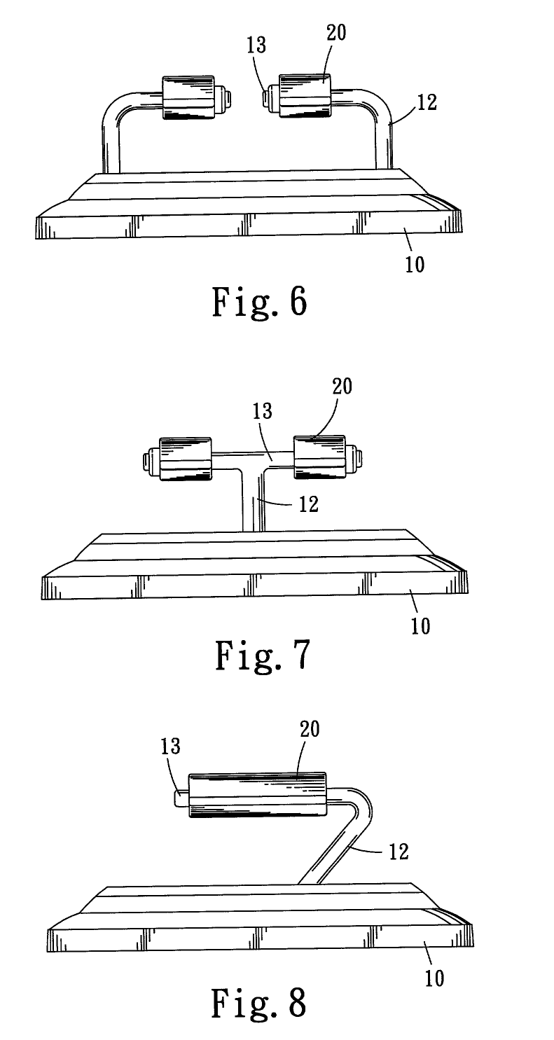

FIGS. 6, 7 and 8 are similar to FIG. 2 but illustrate different preferred embodiments of the supporting means. FIG. 6 illustrates that each of the free ends of the two supporting means (12) has a shaft lever bent inward (13) but the two shaft levers (13) separated, i.e., do not connect with each other. FIG. 7 illustrates that from the back center of the display (10) extends a supporting means (12) that has two shaft levers bent outward (13) at its free end and each of the shaft levers (13) integrates an adjusting unit (20) respectively. FIG. 8 illustrates that from the back center of the display (10) extends an outward deflective supporting means (12) and the free end of the supporting means (12) connects inward a shaft lever (13) that is integrated with an adjusting unit (20).

Theoretically, the shaft lever (13) and the supporting portion (11) can support the display (10) jointly. Another preferred embodiment is that there has a supporting portion (11) at each side of the bottom of the display (10). In other hand, the bottom of the display (10) of course, can be implemented as a plane to form the supporting portion (11).

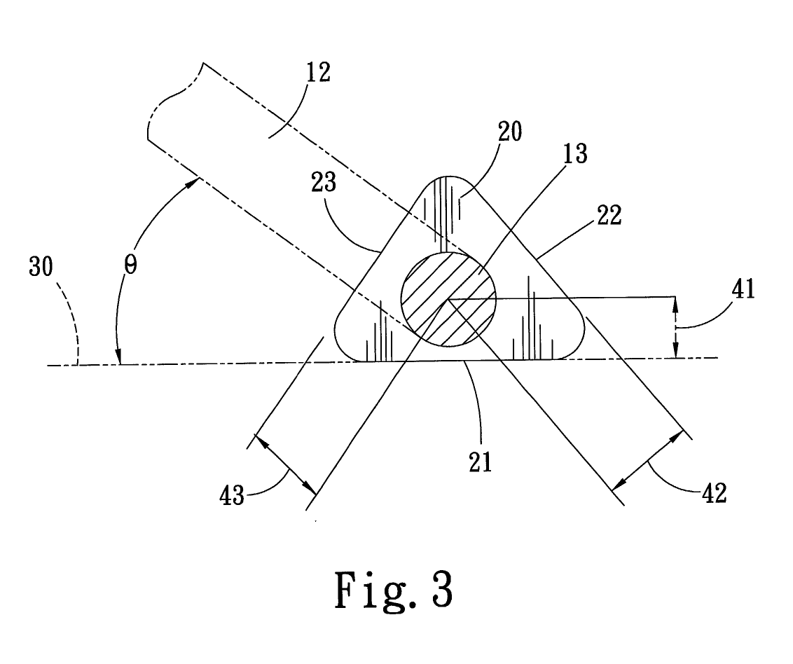

The adjusting unit (20) has multiple planes (21, 22, 23, etc.). FIG. 3 is selective enlargement of FIG. 1 and schematic of the section plane cut along line 3-3 in FIG. 2, which illustrates another preferred embodiment of the section plane of the adjusting unit (20) as a triangle.

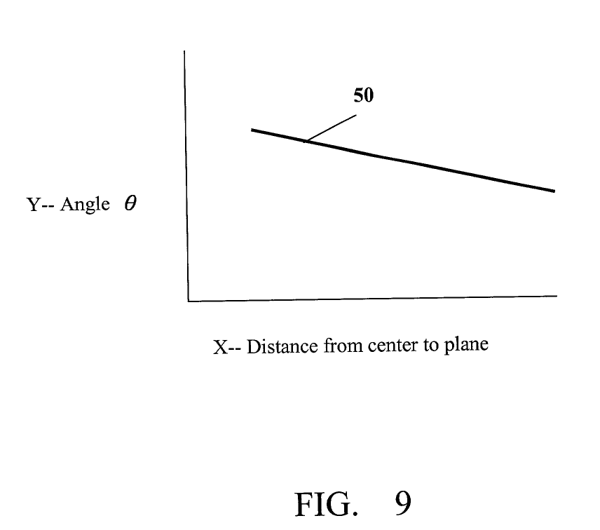

The adjusting unit (20) has three planes (21, 22 and 23). The distances from the virtual center of its shaft hole to the edge of each plane (21, 22 and 23) differ from each other (41, 42 and 43). As shown in FIG. 3, the different distances (41, 42 and 43) will cause the change of the included angle of the supporting means (12) and the platform (30) and therefore change the angle of elevation of the display (10) supported by the supporting means (12). FIG. 9 illustrates the relationship line 50 of how the included angle changes with the change of different distances from the center of shaft hole to the edge of each plane (41, 42 and 43) accordingly, in which coordinate axis Y represents the included angle θ (refer to FIG. 3), and coordinate axis X represents distance from the center of shaft hole to the edge of plane. X and Y are of inverse ratio, i.e., the larger the distance from the center of shaft hole to the edge of plane, the smaller the included angle is.

In structure, the adjusting unit (20) has a shaft hole via which to be pivoted on the shaft lever (13) supporting the display (10) and users can conveniently revolve the adjusting unit (20) manually. The distance from the virtual center of shaft hole of the adjusting unit (20) to each plane (21, 22, 23, etc.) has at least two different lengths. Revolving the adjusting unit (20) to let its different planes (21, 22, 23, etc.) osculate the platform (30) or the desk, the included angle of the supporting means (12) and the platform (30) can be changed. This technology of changing the included angle of the supporting means (12) and the platform (30) can be used to adjust forward or backward angle of elevation of the display (10) accordingly.

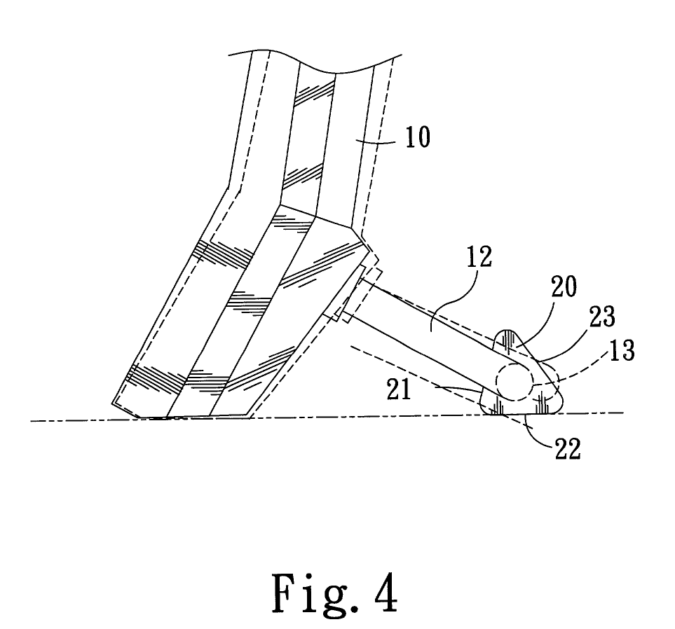

As mentioned above, FIG. 3 illustrates a preferred embodiment that from the center of shaft hole to each plane (21, 22, 23, etc.) there exit three different distances (41, 42, 43, etc.). Therefore, if the adjusting unit (20) is revolved as shown in FIG. 4, the former plane (21) that osculated the platform (30) will be replaced by another plane (22) to osculate the platform (30). Since the distance from the center of shaft hole of the adjusting unit (20) to the plane (22) has changed, the included angle of the supporting means (12) supporting the display (10) and the platform (30) changes accordingly and therefore adjusts the tile angle of the display (10).

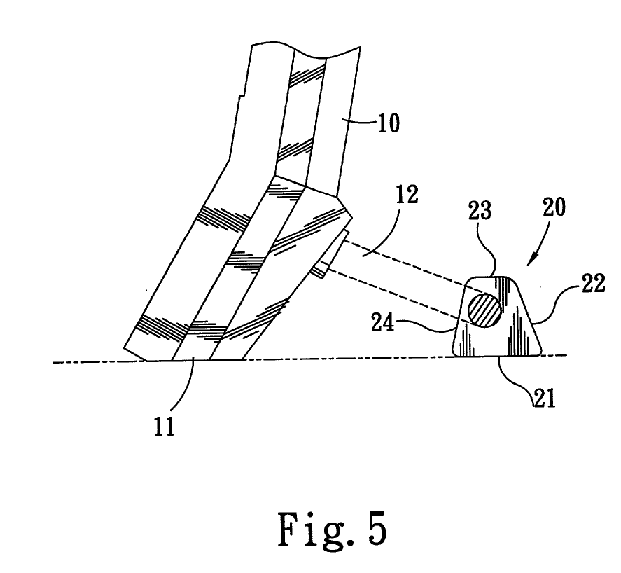

FIG. 5 is similar to FIG. 3 but illustrates another preferred embodiment of the section plane of the adjusting unit (20) as a quadrangle that has four planes (21, 22, 23 and 24). Although FIG. 5 further illustrates an option that the section plane of the adjusting unit (20) can be implemented as a quadrangle, other polyhedrons that are similar to above-mentioned technology of this invention can also be actualized as concrete implementation options based on this technology to achieve the aim of adjusting the angle of elevation of the display (10).

This simple device let users conveniently adjust forward or backward angle of elevation of flat panel display. Generally speaking, the most necessary portion of LCD that needs adjusting is forward or backward angle of elevation and this invention actually provides a technology that is simple in structure but very convenient in use to meet this demand.

Although the above-mentioned figures illustrate some preferred embodiments to give evidence of the operability of this invention in details, they should not confine the following claims of this invention, i.e., if anyone masters this technology and invents a similar device of this invention but has only minor difference in details, will be held legal responsibility of trespassing the originality and patent of this invention.

What is claimed is:

1. An angle of elevation adjusting device for display comprising:
a display adapted a supporting means at the back bottom half of the display, the supporting means having a free end and a shaft lever is adapted thereon; and an adjusting unit pivoted on the shaft lever for supports the display, the adjusting unit has a plurality of plane and the distance from each plane of the adjusting unit to a virtual center of the adjusting unit pivoted on the shaft lever having at least two different lengths.

2. The elevation adjusting device of claim 1, wherein the section plane of said adjusting unit is formed as a triangle.

3. The elevation adjusting device of claim 1, wherein the section plane of said adjusting unit is formed as a quadrangle.

4. The elevation adjusting device of claim 1, wherein said display adapted two supporting means which each having a free end and a bent inward shaft lever is adapted thereon respectively.

5. The elevation adjusting device of claim 4, wherein said two shaft levers separated each other and each of the shaft lever integrates a said adjusting unit respectively.

6. The elevation adjusting device of claim 4, wherein said two shaft levers connect with each other to form a unity.

7. The elevation adjusting device of claim 1, wherein the supporting means adapted at the back center bottom half of the display, the supporting means having a free end and two shaft levers are bent outward adapted thereon respectively; and each of the shaft levers integrates a said adjusting unit.

8. The elevation adjusting device of claim 1, wherein the supporting means bias adapted at the back center bottom half of the display, the supporting means having a free end and a bent inward shaft lever is adapted thereon.

9. The elevation adjusting device of claim 1, wherein said adjusting unit having a shaft hole for pivots on said shaft lever.
